(19) United States
(12) Patent Application Publication
(10) Pub. No.: US 2011/0179770 A1
(43) Pub. Date: Jul. 28, 2011

(54) EXHAUST GAS SYSTEM FOR AN INTERNAL COMBUSTION ENGINE AND METHOD FOR OPERATING AN INTERNAL COMBUSTION ENGINE

(75) Inventor: Simon SCHMUCK-SOLDAN, Royal Oak, MI (US)

(73) Assignee: GM GLOBAL TECHNOLOGY OPERATIONS LLC, Detroit, MI (US)

(21) Appl. No.: 13/014,492

(22) Filed: Jan. 26, 2011

(30) Foreign Application Priority Data
Jan. 27, 2010 (DE) 102010005831.9

(51) Int. Cl. F02B 27/04; F01N 3/10

(52) U.S. Cl. 60/273; 60/299

(57) ABSTRACT

An exhaust gas system is provided for an internal combustion engine that includes, but is not limited to an exhaust gas line and a turbine of an exhaust gas turbocharger. The turbine being situated in the exhaust gas line, the exhaust gas line having a bypass duct leading past the turbine, whose inlet is situated upstream and whose outlet is situated downstream from the turbine in the exhaust gas line, a catalytic converter being situated in the bypass duct.

### CROSS-REFERENCE TO RELATED APPLICATION

This application claims priority to German Patent Application No. 102010005831.9, filed Jan. 27, 2010, which is incorporated herein by reference in its entirety.

### TECHNICAL FIELD

The technical field relates to an exhaust gas system for an internal combustion engine and a method for operating an internal combustion engine comprising an exhaust gas system.

### BACKGROUND

Increasingly higher demands are placed on the performance of internal combustion engines. One possibility for increasing performance is offered by the use of an exhaust gas turbocharger, whose compressor increases the pressure in the intake manifold of the engine and is driven by a turbine in the exhaust gas stream. An exhaust gas turbocharger is typically designed in such a manner that a high boost pressure already results at low engine speed. The boost pressure regulation is performed by a turbine-side bypass, through which a part of the exhaust gas quantity is conducted around the turbine in the case of high speeds and large exhaust gas mass flows.

Furthermore, environmental protection regulations and legal requirements for pollutant emissions are becoming ever stricter. To reduce pollutant emissions, internal combustion engines are equipped with various exhaust gas post-treatment systems. In order to meet existing and future legal requirements for pollutant emissions of internal combustion engines, exhaust gas post-treatment systems must be continuously improved. It is disadvantageous in the case of exhaust gas post-treatment systems in particular that catalytic converters must first be warmed up to operating temperature for effective exhaust gas purification. In particular after a cold start of the internal combustion engine, comparatively cool exhaust gases are initially discharged, which cannot be purified by a still-cold catalytic converter.

In view of the foregoing, at least one object is to reduce the pollutant emissions of internal combustion engines which are equipped with exhaust gas turbochargers. A further object relates to a motor vehicle comprising an exhaust gas system connected to an internal combustion engine. A yet further object relates to a method for operating an internal combustion engine comprising an exhaust gas system. In addition, other objects, desirable features and characteristics will become apparent from the subsequent summary and detailed description, and the appended claims, taken in conjunction with the accompanying drawings and this background.

### SUMMARY

This object is achieved by an exhaust gas system and a method for operating an internal combustion engine comprising an exhaust gas system. The exhaust gas system for an internal combustion engine comprises an exhaust gas line and a turbine of an exhaust gas turbocharger, the turbine being situated in the exhaust gas line, the exhaust gas line having a bypass duct leading past the turbine, whose inlet is situated upstream and whose outlet is situated downstream from the turbine in the exhaust gas line, a catalytic converter being situated in the bypass duct.

The catalytic converter is provided in the bypass duct of the turbine has the advantage that an exhaust gas stream that is conducted past the turbine is purified. This is very advantageous in particular in the cold start phase of an internal combustion engine. The catalytic converter provided in the bypass duct is preferably of small size and therefore can be rapidly heated to its operating temperature and already cause purification of the exhaust gas after a short time. The catalytic converter in the bypass duct is preferably situated close to the engine and can also be referred to as a “closed coupled” catalytic converter. The catalytic converter provided advantageously supplements the function of a main catalytic converter, which is typically provided in any case in the exhaust gas system, for example, situated immediately before the exhaust pipe on the exhaust gas side. During the hot running of the internal combustion engine, however, the main catalytic converter requires a certain amount of time to reach the operating temperature, and can only unfold no or only slight catalytic conversion of the pollutants and thus reduction of the pollutant emissions during this time span.

In particular in the cold running phase of the internal combustion engine, the catalytic converter situated in the bypass duct is first heated by the hot exhaust gases and can reach the operating temperatures significantly more rapidly because of the smaller distance to the internal combustion engine and a preferably smaller size. In particular in the cold start phase, the exhaust gas stream conducted past the turbine, which is not yet required, can thus be effectively purified by the catalytic converter provided in the bypass duct. The inadequate purification by the main catalytic converter, which is typical in the cold running phase, can thus be compensated for. Even if the main catalytic converter is not yet active, the exhaust gas can leave the motor vehicle in purified form.

Through the improved exhaust gas purification, the requirements which are currently already required for the pollutant emission may also be maintained in the cold start phase with little technical expenditure. Furthermore, future requirements for the cold start phase may also be maintained. Furthermore, the requirements for the pollutant emission in the cold start phase may be maintained with lower fuel consumption and improved engine performance.

The pollutant concentration can thus be reduced in particular in the hot running phase after the cold start or in idle of the internal combustion engine. The catalytic converter provided in the bypass duct can thus advantageously both reduce the pollutant emission of a motor vehicle and also optimize the performance of the exhaust gas turbocharger. Furthermore, significant fuel can be saved by the use of the catalytic converter provided in the cold running phase.

Furthermore, it is advantageous that the bypass duct not only advantageously allows the exhaust gas stream to be conducted via the catalytic converter provided in the cold start phase, but rather also that in the event of high speeds and large exhaust gas mass flows, a boost pressure regulation is provided by a regulation of the exhaust gas stream through the turbine. The bypass duct equipped with a catalytic converter can thus regulate the load of the engine if the catalytic converter is not required for purifying the exhaust gas, and can provide purification of the exhaust gas for the case in which it is required, in particular in the cold start phase.

The turbine of the exhaust gas turbocharger preferably has a housing. The bypass duct is preferably formed by the housing. In a preferred embodiment, the catalytic converter situated in the bypass duct is situated in the housing of the turbine of the exhaust gas turbocharger. Integrating the catalytic converter, which is situated in the bypass duct, in the turbine housing represents an advantageous refinement. One advantage of integrating the catalytic converter in the turbine housing is particularly the installation position very close to the engine, whereby the catalytic converter is rapidly heated. The catalytic converter can alternatively be provided in a separate housing.

Furthermore, a compact construction is made possible by a catalytic converter integrated in the turbine housing. The bypass duct can be partially or completely integrated in the turbine housing. This has the advantage that no additional housing is advantageously required. A turbine housing having a favorable structure can be provided in a compact construction. Through a catalytic converter integrated in the turbine housing of the exhaust gas turbocharger, the technical expenditure for attaching the catalytic converter in the bypass line can be reduced. In addition, it is advantageous that this provides a simple implementation of the wastegate function (boost pressure control regulation) and the catalytic converter bypass function.

The catalytic converter provided in the bypass duct and/or the typically provided main exhaust gas catalytic converter are preferably selected from the group comprising oxidation catalytic converters, in particular diesel oxidation catalytic converters, NOₓ storage catalytic converters, also referred to as NOₓ absorbers, particulate filters, in particular catalytically coated particulate filters, and/or three-way catalytic converters. It can be preferable for a combination of the mentioned catalytic converters to be provided. This has the advantage that the exhaust gas comprising pollutants is purified. Catalytic converters are also referred to as catalytic converters.

The bypass duct is preferably a bypass line. The bypass duct is preferably implemented as controllable. In an embodiment, the bypass duct has at least one controllable bypass valve. A controllable bypass valve may particularly expediently be implemented in the form of a bypass flap. The bypass duct preferably has at least one load-controllable and/or speed-controllable bypass flap.

In a further embodiment, the at least one bypass valve, preferably the at least one bypass flap, is situated upstream or downstream from the catalytic converter and/or the turbine in the exhaust gas line. The bypass flap is preferably situated downstream from the catalytic converter. It is advantageous in this case that when the exhaust gas stream is conducted via the turbine, the exhaust gas stream can support the position of the bypass flap. The bypass flap can alternatively also be situated upstream from the catalytic converter. In this case, it can be advantageous that the bypass flap conducts the exhaust gas stream via the turbine and simultaneously prevents the access of the exhaust gas stream via the catalytic converter and can thus protect it.

An actuator is preferably provided for opening or closing the bypass valve, in particular a bypass flap. Variable actuators are possible, for example, an actuator based on an electrical construction, an actuator based on a pneumatic construction, or an actuator based on a hydraulic construction having correspondingly designed actuating means for actuating the bypass valve. In a preferred embodiment, an electrical actuator is provided for actuating the bypass valve, preferably the bypass flap. An electrical activation of the actuator has the advantage of positioning the bypass valve according to engine or thermodynamic criteria, independently of the pressures. An electric motor of an electrical actuator can convert an electrical output signal of the engine control unit directly into a positioning movement of the bypass valve.

Conducting the exhaust gas stream via the turbine and thus bypassing the catalytic converter generates less or no heat dissipation to the catalytic converter. This allows a catalytic converter close to the engine to be operated, without having to cool it during higher-load operation. However, cooling of the catalytic converter may be advantageous with respect to the heat developed by the catalytic converter.

In a further embodiment, the catalytic converter and/or the turbine can have a water cooler and/or an air cooler. A water cooler has the advantage in relation to an air cooler of being able to ensure uniform transport of the heat by a water pump. Furthermore, improved cooling performance can be provided in relation to air coolers. The catalytic converter and/or the turbine may be enclosed by a water-cooled housing, for example. In specific applications, only a specific part of the catalytic converter can also be cooled. In the case of flatly formed catalytic converters, for example, the outer side in relation to the vehicle can be cooled, while the part of the catalytic converter facing toward the engine does not have a water cooler. In particular during higher-load operation, cooling of the turbine can be advantageous.

An internal combustion engine is also provided, which is particularly a turbocharged internal combustion engine. The internal combustion engine is preferably a combustion engine, in particular a diesel or gasoline engine.

an exhaust gas stream alternately being conducted via a catalytic converter situated in a bypass duct and/or a turbine. The exhaust gas stream is preferably conducted via the catalytic converter situated in the bypass duct and/or the turbine by opening and closing a bypass valve of the bypass duct.

A deflection of the exhaust gas stream is advantageous, since the catalytic converter situated in the bypass duct can provide a purification of the exhaust gas during a cold start phase and, in addition, the bypass duct can regulate the performance of the exhaust gas turbocharger and thus the boost pressure as needed during normal operation of the internal combustion engine.

In a preferred embodiment of the method, the exhaust gas stream is conducted through the bypass duct during a cold start of the internal combustion engine and/or during a warm-up phase until reaching the starting temperature of a main exhaust gas catalytic converter.

It is advantageous that the bypass duct allows a path of the exhaust gas stream via the catalytic converter situated in the bypass duct, while avoiding the turbine. In particular during a cold start phase, the exhaust gas stream can be entirely or partially conducted through the bypass duct via the catalytic converter situated in the bypass duct. This is very advantageous in particular in the cold start phase of an internal combustion engine, since the main catalytic converter is not yet sufficiently heated in the cold start phase to be able to provide effective purification of the exhaust gas. The catalytic converter provided in the bypass duct is, on the one hand, favorably situated close to the engine at a short distance from the internal combustion engine and, on the other hand, preferably of small size and can therefore be heated more rapidly to its operating temperature than the main catalytic converter. In this way, the exhaust gas stream can already be effectively purified at an early point in time in a cold start phase. The purification by the main catalytic converter, which is typically inadequate in the cold running phase, can thus be supplemented. To minimize the exhaust gas emissions, it is therefore advantageous to conduct the greatest possible exhaust gas stream via the catalytic converter situated in the bypass duct during the cold start. A higher exhaust gas stream further has the self-reinforcing effect of also accelerating the heating of the catalytic converter.

In further preferred embodiments of the method, the exhaust gas stream is conducted as needed through the bypass duct to regulate the turbine at temperatures of the main exhaust gas catalytic converter above the starting temperature. In the case of hot-running internal combustion engine, the exhaust gas stream can be regulated as needed by the bypass duct, in order to regulate the exhaust gas stream via the turbine and thus the performance of the exhaust gas turbocharger or the boost pressure.

In the case of higher-load operation of the engine when the main catalytic converter has reached its temperature, the full exhaust gas mass flow or no exhaust gas mass flow is advantageously not applied to the catalytic converter in the bypass duct by using the turbine. In this way, the effective exhaust gas counter pressure is reduced. The performance of the engine thus increases and the engine combusts more efficiently and/or with less consumption.

### BRIEF DESCRIPTION OF THE DRAWINGS

The present invention will hereinafter be described in conjunction with the following drawing figures, wherein like numerals denote like elements, and:

FIG. 1 shows a schematic diagram of an exhaust gas system having open bypass flap; and

FIG. 2 shows a schematic diagram of the exhaust gas system from FIG. 1 having closed bypass flap.

### DETAILED DESCRIPTION

The following detailed description is merely exemplary in nature and is not intended to application and uses. Furthermore, there is no intention to be bound by any theory presented in the preceding background or summary or the following detailed description.

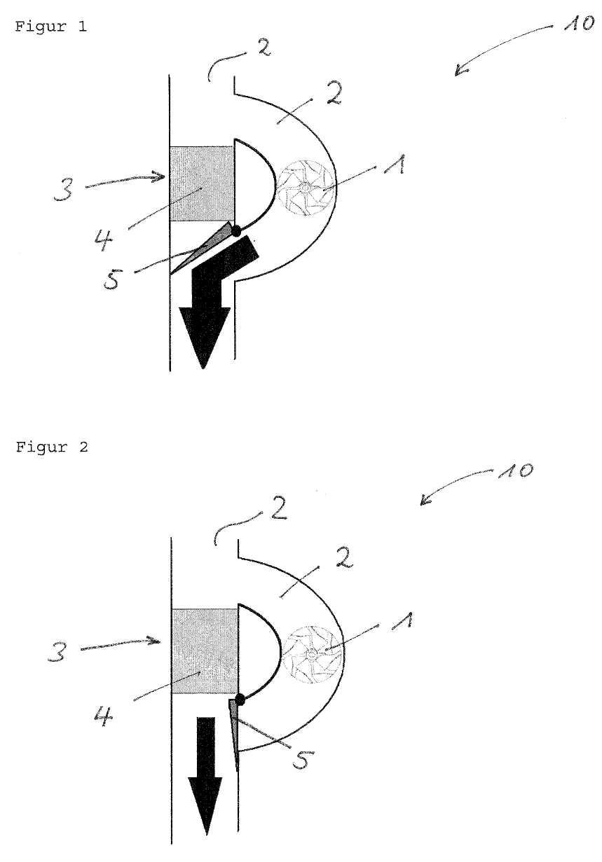

FIG. 1 schematically shows an exemplary embodiment of an exhaust gas system for an internal combustion engine. A turbine 1 of an exhaust gas turbocharger is situated in an exhaust gas line 2 of the exhaust gas system 10. The exhaust gas line 2 has a bypass line 3 leading past the turbine 1 of the exhaust gas turbocharger. The inlet of the bypass line is situated upstream and the outlet is situated downstream from the turbine 1 in the exhaust gas line 2. A catalytic converter 4 is situated in the bypass line 3. To control the exhaust gas stream through the bypass line 3, a bypass flap 5 is provided, which is situated downstream from the turbine 1 in the exhaust gas line 2. By completely opening the bypass flap 5, the exhaust gas flows via the turbine 1, as is recognizable on the basis of the flow direction of the exhaust gas stream shown by the arrow in FIG. 1. This is the case, for example, when the internal combustion engine is operating hot after reaching the operating temperature of the main catalytic converter.

The bypass flap 5 is shown in the closed state in FIG. 2. Through the complete closing of the bypass flap 5, the exhaust gas flows via the catalytic converter 4, as is recognizable on the basis of the flow direction of the exhaust gas stream shown by the arrow in FIG. 2. This is the case, for example, in a cold start phase. Thus, purified exhaust gas leaves the motor vehicle, even if the main catalytic converter is not yet active.

The bypass flap 5 can assume intermediate positions as needed, notwithstanding incomplete opening or complete closing, in order to regulate the exhaust gas stream via the turbine 1 and thus the performance of the turbocharger and the boost pressure. This essentially corresponds to the function of a so-called wastegate.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An exhaust gas system for an internal combustion engine, comprising:
an exhaust gas line comprising a bypass duct;
a turbine situated in the exhaust gas line,
wherein the exhaust gas line is adapted to lead past the turbine whose inlet is situated upstream and whose outlet is situated downstream from the turbine in the exhaust gas line; and
a catalytic converter situated in the bypass duct.

2. The exhaust gas system according to claim 1, further comprising a housing for the turbine, wherein the catalytic converter is situated in the bypass duct that situated in the housing.

3. The exhaust gas system according to claim 1, wherein the bypass duct comprises a controllable bypass valve.

4. The exhaust gas system according to claim 3, wherein the controllable bypass valve is a load-controllable bypass flap.

5. The exhaust gas system according to claim 3, wherein the controllable bypass valve is a speed-controllable bypass flap.

6. The exhaust gas system according to claim 1, further comprising a bypass valve situated upstream from the catalytic converter and/or the turbine in the exhaust gas line.

7. The exhaust gas system according to claim 1, further comprising a bypass valve situated downstream from the catalytic converter and/or the turbine in the exhaust gas line.

8. The exhaust gas system according to claim 1, further comprising a bypass valve situated upstream from the turbine in the exhaust gas line.

9. The exhaust gas system according to claim 1, further comprising a bypass valve situated downstream from the turbine in the exhaust gas line.

10. The exhaust gas system according to claim 1, further comprising an electrical actuator adapted to actuating a bypass valve.

11. The exhaust gas system according to claim 1, wherein the catalytic converter a water cooler.

12. The exhaust gas system according to claim 1, wherein the catalytic converter comprises an air cooler.

13. The exhaust gas system according to claim 1, wherein the turbine comprises a water cooler.

14. The exhaust gas system according to claim 1, wherein the turbine have an air cooler.

15. A motor vehicle comprising:
an internal combustion engine; and
an exhaust gas system connected to the internal combustion engine, the exhaust gas system comprising:
an exhaust gas line comprising a bypass duct;
a turbine situated in the exhaust gas line,
wherein the exhaust gas line is adapted to lead past the turbine whose inlet is situated upstream and whose outlet is situated downstream from the turbine in the exhaust gas line; and
a catalytic converter situated in the bypass duct.

16. A method for operating an internal combustion engine comprising an exhaust gas system, the exhaust gas system comprising:
an exhaust gas line comprising a bypass duct;
a turbine situated in the exhaust gas line,
wherein the exhaust gas line is adapted to lead past the turbine whose inlet is situated upstream and whose outlet is situated downstream from the turbine in the exhaust gas line; and
a catalytic converter situated in the bypass duct,
the method comprising alternately conducting an exhaust gas stream with the catalytic converter.

17. The method according to claim 16, further comprising:
performing a cold start of the internal combustion engine; and
conducting the exhaust gas stream through the bypass duct during the cold start.

18. The method according to claim 16, further comprising:
performing a warm-up phase of the internal combustion engine; and
conducting the exhaust gas stream through the bypass duct during the warm-up phase.
